(19) United States
(12) Patent Application Publication
(10) Pub. No.: US 2026/0001732 A1
(43) Pub. Date: Jan. 1, 2026

(54) FOOD CAN STACKING DEVICE

(71) Applicant: Kevin James Baldwin, Tipton, IN (US)

(72) Inventor: Kevin James Baldwin, Tipton, IN (US)

(21) Appl. No.: 18/757,411

(22) Filed: Jun. 27, 2024

(51) Int. Cl. B65G 57/00

(52) U.S. Cl. CPC B65G 57/005; B65G 2201/0252

(57) ABSTRACT

A food can stacking device for efficiently and safely stacking food cans that were not originally designed to stack. The food can stacking device's geometry is such that it can be used when the food can has additional can construction items, such as pull tabs, or damage to the can's rim.

### CROSS-REFERENCE TO RELATED APPLCIATIONS

Provisional application No. 63/510,313, filed on Jun. 26, 2023.

### STATEMENT REGARDING FEDERALLY SPONSORED RESEARCH OR DEVELOPMENT

Not applicable.

### REFERENCE TO A SEQUENCE LISTING, A LARGE TABLE, OR A COMPUTER PROGRAM LISTING APPENDIX ON READ-ONLY OPTICAL DISC

Not applicable.

### BACKGROUND OF THE INVENTION

The invention relates generally to any industry that utilizes metal cans for storing product and more specifically relates to the food industry where the supplier and consumer stack food cans on top of each other.

### BRIEF SUMMARY OF THE INVENTION

While stacking food cans in any location, a shortfall in design was noticed, in that not all manufacturers of food cans offer food cans with necked-in tops or bottoms. When a food can is “necked-in”, it means that the diameter of the bottom (typically) of the food can is reduced slightly so that it may be placed on the top (typically) of another food can, in order that they may be easily stacked. Some food can manufacturers still produce food cans with tops and bottoms with the same outer dimension. These are commonly referred to as a “three-piece can” or a “two-piece can”, where the top and bottom contain the same outside diameter, or length and width, and they cannot be efficiently or safely stacked. These are just a couple examples. There are other types of food cans, including those using other methods and materials, that still do not allow stacking of the cans on top of each other in a safe or efficient manner. The purpose of the invention, which will be described subsequently in greater detail, is to allow non-stackable, or non-necked-in, food cans to stack. This stacking is not only more efficient to save space where the food cans are stored, whether at the supplier or consumer, but it also provides for safety, as it prevents the top can from falling off the bottom can when bumped or under vibration. When a task is performed that causes movement of the food can such as opening and closing a cupboard door, or a consumer simply picking up and setting down a food can on the shelf at the store, the food can stacking device will allow these food cans to stack and remain stacked.

### BRIEF DESCRIPTION OF THE SEVERAL VIEWS OF THE DRAWINGS

The invention's advantages will become better understood in conjunction with the accompanying drawings, in which like reference the unique attributes of the invention, wherein:

FIG. 1 is an orthographic projection view of the invention.

FIG. 2 is a usage example with a front perspective view of the invention.

### DETAILED DESCRIPTION OF THE INVENTION

Before explaining at least one embodiment of the invention in detail, it is to be understood that the invention is not limited in its application to the details of construction or to the specifications set forth in this description or illustrated in the drawings. Also, it is to be understood that the phraseology and terminology employed herein are for the purpose of the description and should not be regarded as limiting.

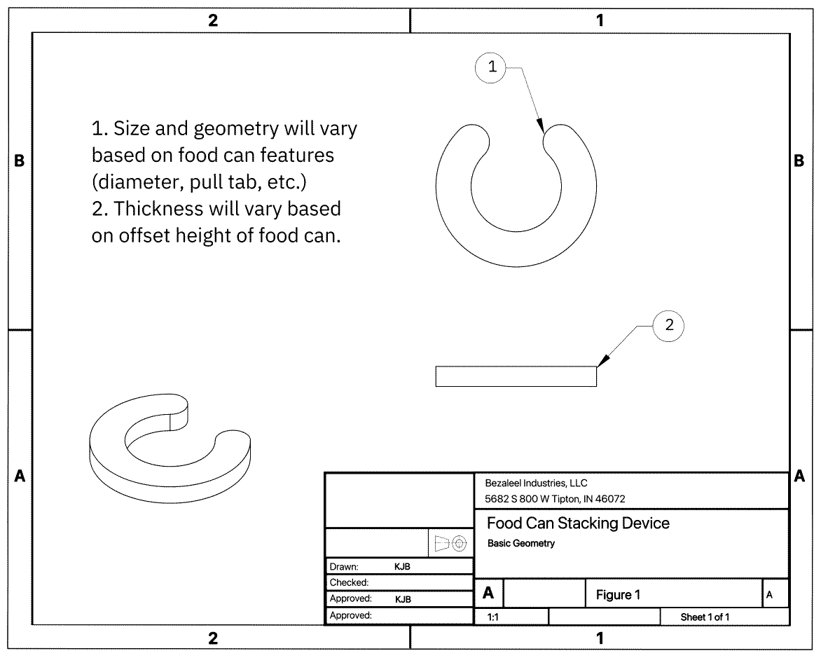

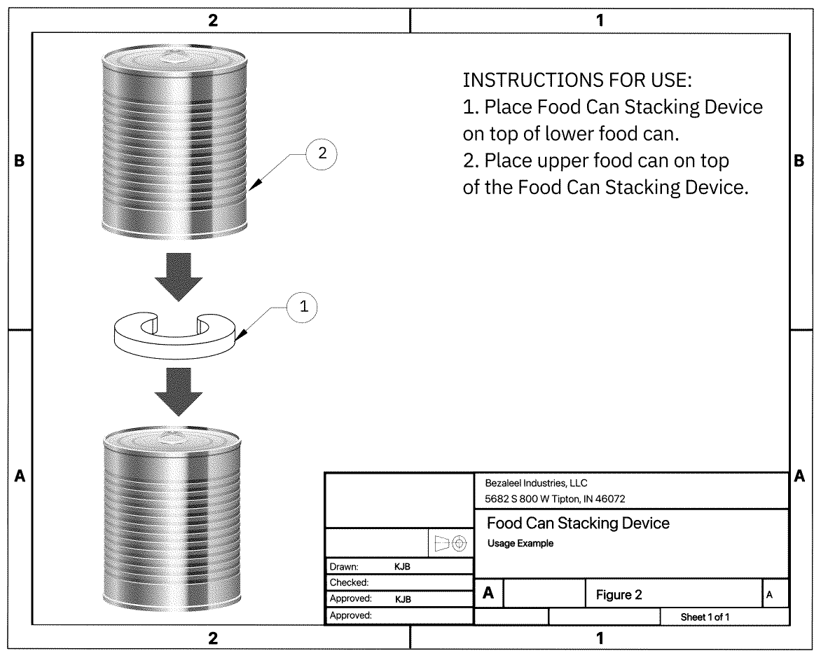

Turning now descriptively to the drawings, FIG. 1 shows the form of the article that contains the appropriate geometric dimensions to fit on top of one food can and allow the placement of another food can on top of the device. The purpose of the device is to fit inside the inner diameter of the lower can's top rim, accounting for any additional items such as a pull tab for opening, or perhaps damage to the can's rim (dent), while simultaneously allowing the inner diameter of the upper can's bottom rim to fit over top of the device. This allows the two food cans to stack on top of each other. The device has a custom-designed geometry that allows for proper fit, and the geometry includes gaps, radiuses, spaces, or bossing where necessary. Notice how item #1 of FIG. 1 points to the inner geometry required to accommodate for items such as a pull tab or perhaps a dent in the can. This design, which is not anticipated, rendered obvious, suggested, or even implied by any prior art, is what makes the food can stacking device unique, and has been custom designed and tested to be used with several different shapes and sizes of food cans. The food can stacking device can be 5 laser cut, machined, cast, or molded from raw materials, depending on the usage case and quantity required. The thickness of the device, as illustrated with item #2 of FIG. 1, is determined by the height of the food can rim. FIG. 2 provides an illustration of how the device is intended to be used and includes a two-step instruction. Item #1 of FIG. 2 shows the food can stacking device being placed on top of the lower can. Item #2 of FIG. 2 shows the upper food can being placed on top of the food can stacking device.

I claim:

1. A food can stacking device, comprising:
An article having a geometry contoured to fit inside the top rim of a food can;
wherein said article has a geometry configured to accommodate food can construction.
